(19) United States
(12) Patent Application Publication
(10) Pub. No.: US 2012/0249354 A1
(43) Pub. Date: Oct. 4, 2012

(54) RADAR DETECTOR CAPABLE OF TURNING ON AND OFF THE POWER OF OSCILLATORS

(76) Inventor: Dong Ryeol KIM, Kyeonggi-do (KR)

(21) Appl. No.: 13/097,464

(22) Filed: Apr. 29, 2011

(30) Foreign Application Priority Data
Apr. 4, 2011 (KR) 10-2011-0030828

(51) Int. Cl. G01S 7/42

(52) U.S. Cl. 342/20

(57) ABSTRACT

A radar detector capable of turning on and off the power of oscillators in accordance with the present disclosure, for detecting existence of a signal of a predetermined frequency through a signal processing unit comprising at least one oscillating unit that receives, through an antenna, electromagnetic waves generated from outside and that generates the signal of the predetermined frequency, and for displaying detection result to a user, comprises an oscillating unit controller for turning on/off the power supplied to the at least one oscillating unit.

### CROSS-REFERENCE TO RELATED APPLICATION

This application claims the benefit and priority to Korean Patent Application No. 10-2011-0030828, filed Apr. 4, 2011. The entire disclosure of the application identified in this paragraph is incorporated herein by reference.

### FIELD

This disclosure generally relates to a radar detector. More specifically, this disclosure relates to a radar detector capable of turning on and off the power of oscillators so as to reduce unnecessary time of operation by turning on and off manually or automatically after a predetermined period of time the power supplied to the oscillators that generate high-frequency signals, for example, to detect high-frequency signals generated from external devices.

### BACKGROUND

This section provides background information related to the present disclosure which is not necessarily prior art.

In general, since every road on which motor vehicles run is regulated with upper or lower speed limits depending on the conditions of each road, drivers are expected not to drive over legal speed limits in each road.

However, though roadway conditions have been continuously improved and automobile performance and safety have been enhanced, since speed limits regulated by traffic laws established when road conditions were poor and automobiles were not as powerful and safe as these days have rarely been raised, most of the drivers actually run their cars over the speed limits more or less from time to time.

On the one hand, since speeding is one of the top causes of traffic accidents, it is necessary to monitor speeding for practical reasons. Thus, many industrialized countries have made efforts to promote traffic safety using various speed detecting systems with different microwaves or laser and safety alarm transmitters for alerting various dangerous or risky road conditions.

Especially in the United States, the use of speed detecting systems and signal detectors are legal in many states and around two million units of such gadgets are sold annually. In addition, many countries around the world are increasingly legalizing the use of speed detecting systems and signal detectors.

The above-described speed detecting systems and signal detectors comprise a detector main body 1, a lighter socket jack 2, and a power cable connecting the detector main body 1 to the lighter socket jack 2 as shown in accompanying FIG. 1.

The kind of signals used in such speed detecting systems and signal detectors includes the following signals depending on apparatus to be used.

That is, speed guns for detecting the speed of a running vehicle to monitor speeding automobiles use Ko-band (9.9 GHz), X-band (10.525 GHz), Ku-band (13.45 GHz), K-band (24.15 GHz), superwide Ka-Band (widely distributed in 33-36 GHz), laser (with a wavelength of 800 nm-1100 nm) and the like, and safety alert systems for alerting road information to promote traffic safety use the frequency of 24.070 to 24.230 GHz to transmit three different kinds of information of railroad crossings, work zones, and emergency vehicles. Furthermore, safety warning systems use the frequency of 24.075 to 24.125 GHz to transmit sixty four different kinds of coded information such as fog areas, work zones, school zones, reduced speed limits and so on.

Popularity of such safety-related transmitter/receiver systems has been widespread in the United States and is starting to receive considerable attention around the world, thereby providing high expectation in connection with next-generation intelligent transportation systems (ITS).

All the above-mentioned frequencies and their use are regulated by the Federal Communications Commission (FCC) of the United States.

A block configuration of a system capable of detecting various such signals is shown in accompanying FIG. 2. FIG. 2 is an exemplary block diagram of the prior art detector main body 1 shown in FIG. 1, and illustrates the configuration of a radar detector 100 disclosed in Korean Patent No. 10-0986561 which was issued on Oct. 1, 2010 to the applicant of the present application.

The radar detector 100 has an advantage of improving delivery of more accurate information to drivers through connection with a navigation system and various devices equipped with LCD monitors for providing a variety of audio-visual information in case of embedding information related to roadway conditions in a high-frequency signal emitted by a speed gun used as a detection signal for monitoring speeding, unlike conventional methods in which the passage of such information to drivers has been limited.

In configuration, the radar detector 100 comprises an input unit 113, a display unit 114, a controller 110, a horn antenna 101, a first local oscillating unit 102, a first mixing unit 103, a first amplifying unit 104, a second local oscillating unit 105, a second mixing unit 106, a second amplifying unit 107, a filtering unit 108, a digital signal supply unit 109, a laser detecting unit 111, an audio signal output unit 115, an input connector 112, and an output connector 116.

The input unit 113 is a means comprising one or more buttons for switching functions and for changing operation status and so on of the detector main body by a user. For example, a driver can use the input unit 113 to activate a mute function for shutting off audio outputs, a dimmer function for adjusting the brightness of the display unit 114, a function for adjusting the sensitivity of signal reception and the like.

The display unit 114 is a means for visually displaying current operation status, messages and the like corresponding to analyzed data under the control of the controller 110 in a display form of letters, figures, and graphics. For instance, the display unit 114 may comprise one or more LEDs (light emitting diodes) for displaying current status (such as under operation of a function, a warning status and so on).

The controller 110 measures and calculates the period and amplitude of a digital signal, generates analysis data by analyzing the information and the band of the signal, and in particular, controls the first and second local oscillating units 102 and 105 to determine the information and the kind of signals over time. The controller 110 also outputs messages (such as, speed limits, messages related to current situation, current driving speed and so on) corresponding to the generated analysis data through the display unit 114 or the audio signal output unit 115, and changes operation status, switches functions and the like of the detector main body in response to a function control signal entered through the input unit 113.

In addition, the controller 110 determines what kind of function a pulsed waveform signal is designed to correspond with, the pulsed waveform signal being received along with electric power from a power source (for example, DC 12V) such as an automotive battery 3 through the power cable and the lighter socket jack 2, and performs corresponding operations (for instance, switching functions, changing operation status and so on). In this case, the controller 110 is designed such that while the pulsed waveform signal is being fed to the detector main body, steady electric driving power is not supplied to the detector main body.

Furthermore, though not shown in detail, the controller 110 may comprise a microprocessor such as an MPU or a CPU and a built-in or external memory device, and may further comprise a device such as a counter for measuring the passage of time. The memory device of the controller 110 is a means for storing an operating program of the detector main body, messages to be outputted through the display unit 114 or the audio signal output unit 115, function setting information corresponding to the pulsed waveform signals and so on.

The horn antenna 101 is a means for receiving signals of certain frequencies such as X-band frequency (10.525 GHz), K-band frequency (24.150 GHz), Ka-band frequency (34.7 GHz±1.3 GHz) and the like emitted from, for example, a speed gun or the like. The first mixing unit 103 mixes the signal of a certain frequency received by the horn antenna 101 and delivered thereto with a signal of variable frequency generated at the first local oscillating unit 102. In other words, after receiving a signal from the horn antenna 101, the first mixing unit 103 converts the frequency of the received signal to a first intermediate frequency using a first local oscillating frequency generated at the first local oscillating unit 102. The first amplifying unit 104 amplifies the first intermediate frequency which has been mixed by the first mixing unit 103.

The second mixing unit 106 mixes the signal amplified at the first amplifying unit 104 with a signal of a second local oscillating frequency generated at the second local oscillating unit 105. That is, the signal of the first intermediate frequency mixed and amplified at the first mixing unit 103 and the first amplifying unit 104 is mixed with a signal of a frequency predetermined according to the band of the received signal among the frequencies of the second local oscillating unit 105 at the second mixing unit 106 consisting of strip lines and is converted to a signal of a second intermediate frequency.

The second local oscillating unit 105 may be designed to separately oscillate at frequencies of 265 MHz and 1,030 MHz, and to alternately oscillate continuously regardless of the existence of received signals. Accordingly, since the second local oscillating unit 105 can receive another signal of a different band while receiving a signal and a priority of the received signals can be entered to the controller 110, a signal of the band with the highest priority can be received and converted immediately while other signals are being received.

The second amplifying unit 107 amplifies the signal of the second intermediate frequency which has been mixed by the second mixing unit 106, and the filtering unit 108 is a means for filtering signals (that is, removing noise components) amplified at the second amplifying unit 107. The digital signal supply unit 109 is a means for detecting signals that have passed the filtering unit 108 and for converting and outputting the detected signals to digital signals. And, the laser detecting unit 111 is a means for receiving laser signals. The audio signal output unit 115 amplifies the audio data provided by the controller 110 and outputs audio signals.

The controller 110 and other components are connected to the lighter socket jack 2 through the input connector 112 via the power cable, so that they can be supplied with DC power (for example, DC 12V or DC 24V) from the automotive battery 3 (refer to FIG. 4)

The output connector 116 transmits data to external devices such as a navigation system and the like so as to visually output them. In general, since the display unit 114 of the radar detector is an LED display device of a seven-segment type, the method of visual representation has been limited so far. Therefore, the radar detector 100 shown in FIG. 2 provides an advantage of outputting visual information having various graphical effects easily recognizable by a user through an external device, by using the external device comprising a display capable of supporting various representations with a relatively large display area.

However, the constitution of the prior art radar detector 100 as described above has a disadvantage of entailing very high power consumption. In other words, the radar detector 100 consumes a large amount of power because, in order to receive signals of certain frequencies such as x-band frequency (10.525 GHz), K-band frequency (24.150 GHz), Ka-band frequency (34.7 GHz±1.3 GHz) and the like emitted from, for example, a speed gun, the radar detector continuously drives oscillators such as the first and second oscillating units 102 and 105 since the radar detector has been turned on. Because such a radar detector of a continuously oscillating type is quite inefficient when installed and used in a car, there is a need for improving such radar detector to be power-efficient.

### SUMMARY

This section provides a general summary of the disclosure and is not a comprehensive disclosure of its full scope or all of its features.

The present disclosure provides various advantages to the above-described prior art radar detector of a continuously oscillating type by improving and overcoming the drawbacks thereof. The present disclosure provides a radar detector capable of turning on and off the power of oscillators so as to reduce unnecessary time of operation by turning on/off manually by a user or automatically after a predetermined period of time the power supplied to the oscillators that generate high-frequency signals to detect high-frequency signals generated from external devices such as a speed gun for monitoring speeding.

In addition, the present disclosure provides convenience to users by improving limited power supply connections in automobiles, by associating a radar detector with various devices such as navigations, mobile phones, smart PCs and so on with not only data communications but also power supply.

The objectives above can be achieved by a radar detector capable of turning on and off the power of oscillators as described in this disclosure.

A radar detector capable of turning on and off the power of oscillators provided by an aspect of the present disclosure, for detecting existence of a signal of a predetermined frequency through a signal processing unit comprising at least one oscillating unit that receives, through an antenna, electromagnetic waves generated from outside and that generates the signal of the predetermined frequency, and for displaying detection result to a user, comprises an oscillating unit controller for turning on/off the power supplied to the at least one oscillating unit.

In an embodiment, the power supplied to the oscillating unit controller may be configured to be turned on/off manually by a user.

In another embodiment, the power supplied to the oscillating unit controller may be configured to be turned on/off automatically according to settings of a pre-installed operating program.

In yet another embodiment, the power supplied to the oscillating unit controller may be configured to be turned on automatically after a certain period of time preset according to settings of a pre-installed operating program after a user manually turns off the power.

In still another embodiment, the radar detector may further comprise an input connector for receiving power from an external DC power source and for converting received power to power appropriate for each component therein and supplying the power to the component. Furthermore, the input connector may further comprise a switch for turning on/off input power.

In still another embodiment, the radar detector may further comprise an output connector capable of supplying DC power to an external device.

In still yet another embodiment, the radar detector may further comprise an output connector capable of supplying data to be visually displayed to an external device.

The present disclosure having the configuration described above has effects of reducing unnecessary time of operation by turning on/off manually by a user or automatically after a predetermined period of time the power supplied to oscillators that generate high-frequency signals to detect high-frequency signals generated from external devices such as a speed gun for monitoring speeding, and of promoting user convenience by improving limited power supply connections in automobiles by associating a radar detector with various external devices such as navigations, mobile phones, smart PCs and so on with not only data communications but also power supply.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 is a schematic diagram illustrating an exemplary installation of a general radar detector in an automobile.

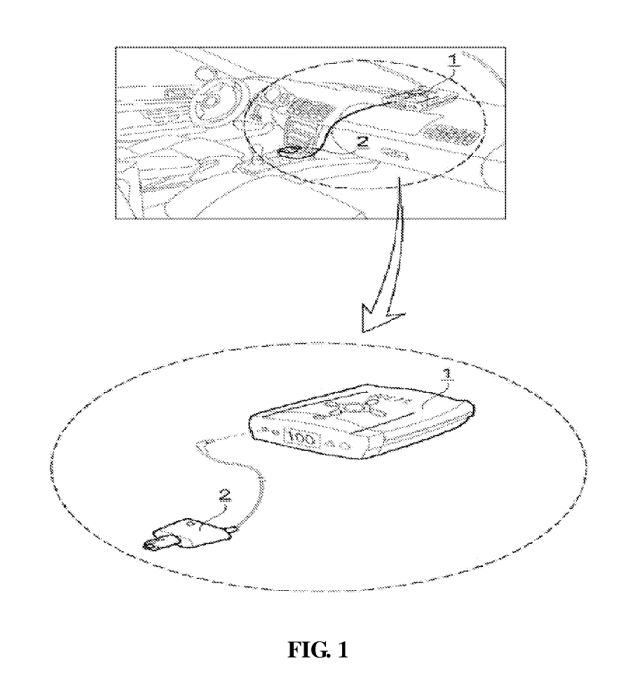

FIG. 2 is a schematic block diagram illustrating an internal configuration of a conventional radar detector.

FIG. 3 is a schematic block diagram illustrating an internal configuration of a radar detector capable of turning on and off oscillators in accordance with an embodiment of the present disclosure.

FIG. 4 is a schematic block diagram illustrating a configuration for connecting a radar detector capable of turning on and off oscillators in accordance with an embodiment of the present disclosure to external devices.

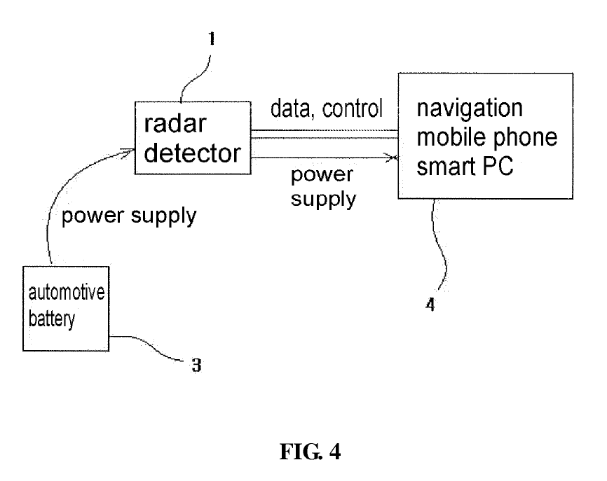

### BRIEF DESCRIPTIONS OF DRAWINGS

1, 100, 200: radar detector
2: lighter socket jack
3: automotive battery
4: external device
101: horn antenna
102: first local oscillating unit
103: first mixing unit
104: first amplifying unit
105: second local oscillating unit
106: second mixing unit
107: second amplifying unit
108: filtering unit
109: digital signal supply unit
110: controller
111: laser detecting unit
112: input connector
113, 130: input unit
114: display unit
115: audio signal output unit
116, 140: output connector
120: oscillating unit controller

### DETAILED DESCRIPTION

The present disclosure will now be described in detail with reference to the accompanying drawings.

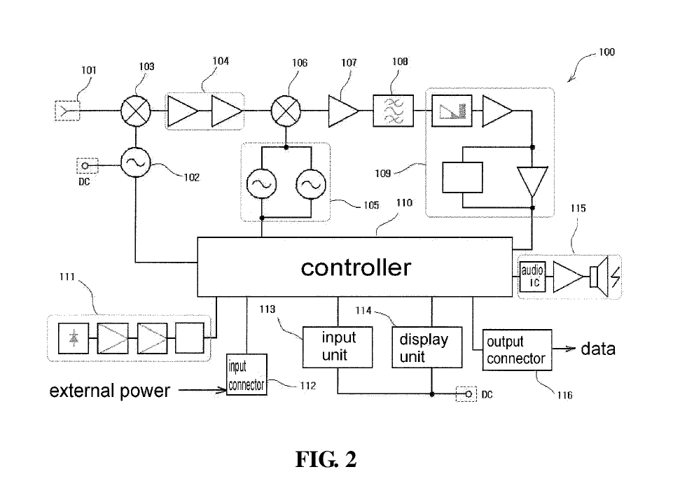

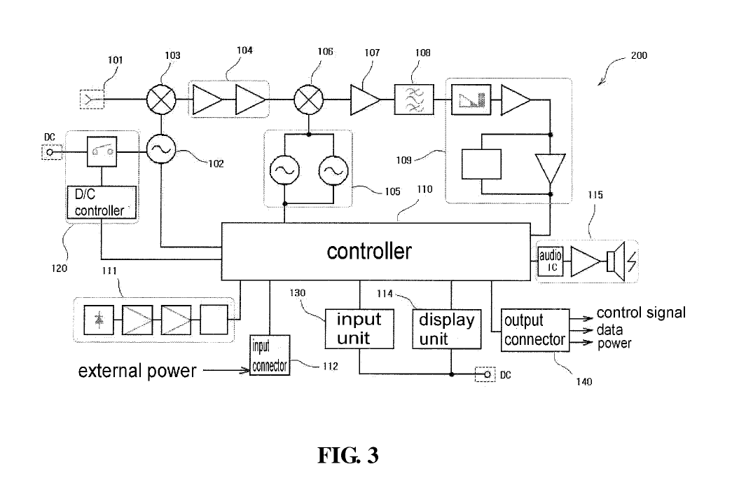

FIG. 3 illustrates an internal configuration of a radar detector 200 in accordance with the present disclosure, and the radar detector 200 has a configuration similar to that of the radar detector 100 illustrated in FIG. 2. The radar detector 200 is an apparatus for detecting existence of a signal of a predetermined frequency through a signal processing unit comprising at least one oscillating unit (oscillator) that receives, through an antenna, electromagnetic waves generated from outside and that generates the signal of the predetermined frequency. The radar detector 200 can display detection results to a user.

As shown in FIG. 3, the radar detector 200 comprises an input unit 130, a display unit 114, a controller 110, a horn antenna 101, a first local oscillating unit 102, a first mixing unit 103, a first amplifying unit 104, a second local oscillating unit 105, a second mixing unit 106, a second amplifying unit 107, a filtering unit 108, a digital signal supply unit 109, a laser detecting unit 111, an audio signal output unit 115, an input connector 112, an output connector 140, and an oscillating unit controller 120.

The radar detector 200 includes improvements over a conventional radar detector 100 illustrated in FIG. 2. Some parts of the radar detector 200 are similar to those of the radar detector 100, and omitted descriptions for some parts can be found in Korean Patent No. 10-0986561.

Conventional radar detectors 100 consume excessive power because oscillating units 102, 105 are under continuous oscillation. In an embodiment, to reduce power consumption of a radar detector, a radar detector of this disclosure comprises an oscillating unit controller 120 capable of turning on/off the power supplied to at least one oscillating unit 102, 105.

As shown in the embodiment, the oscillating unit controller 120 may comprise a switch for turning on/off DC power supplied to the first oscillating unit 102 and other components such as a D/C controller for controlling and activating the switch at the controller 110. The configuration of the oscillating unit controller 120 in accordance with the embodiment is advantageous in case of turning off the first oscillating unit 102 for a short time because while other components of the radar detector 200 are still being supplied with power, only the power fed to the first oscillating unit 102 is turned on/off and accordingly response of turning on/off the first oscillating unit 102 can be fast.

Though not shown in the example, the oscillating unit controller 120 may also be configured to turn on/off not only the power supplied to the first local oscillating unit 102 but also the power supplied to the second local oscillating unit 105 at the same time. Alternatively, it would be obvious to those skilled in the art to configure the oscillating unit controller 120 to turn on/off only the power supplied to the second local oscillating unit 105.

In accordance with an embodiment of the disclosure, it is also possible to configure to turn on/off the power supplied to the oscillating unit controller 120 manually, for example, by a user. That is, when a user presses an oscillating unit on/off button provided on the input unit 130, the controller 110 drives the oscillating unit controller 120, so that the overall radar detector 200 still operates, whereas the operation of the first local oscillating unit 102 can be stopped. Then, the user can press the same button again or a separate oscillating unit off button to make the controller 110 drive the oscillating unit controller 120, so that the first local oscillating unit 102 operates normally.

In another embodiment, it is possible to configure to automatically turn on/off the power supplied to the oscillating unit controller 120 in accordance with settings of a pre-installed operating system. This is a method of automatically controlling the oscillating unit controller 120 by the controller 110 according to what is set on a pre-installed operating program in a configuration where the controller 110 operates according to the operating program. For example, a user can select “city mode” or “country mode” as the drive mode of the radar detector 200. Then, the controller 110 drives the oscillating unit controller 120 at a specific time based on predetermined criteria in accordance with “city mode” or “country mode,” so that the overall radar detector 200 still operates, whereas the operation of the first local oscillating unit 102 can be stopped. Then, the controller 110 drives the oscillating unit controller 120 again after a certain period of time based on predetermined criteria in accordance with a selected mode, thereby controlling the first local oscillating unit 102 to operate normally.

In yet another embodiment, it is possible to configure to automatically turn on the power supplied to the oscillating unit controller 120 after a pre-set period of time in accordance with settings of a pre-installed operating program if a user manually turns off the power. In other words, when a user presses an oscillating unit on/off button provided on the input unit 130, the controller 110 drives the oscillating unit controller 120, so that the overall radar detector 200 still operates, whereas the operation of the first local oscillating unit 102 can be stopped. Thereafter, the controller 110 drives the oscillating unit controller 120 again after a pre-set period of time in accordance with settings of a pre-installed operating program, so that the first local oscillating unit 102 operates normally.

In still another embodiment, the radar detector 200 may further comprise an input connector 112 for receiving power from an external DC power source which may be, for example, an automotive battery and for converting the received power to power appropriate for each component and supplying the power to the component, so that the radar detector 200 can be used as an automobile installation. In this case, the input connector 112 may comprise a power cable and a lighter socket jack 2, and may further comprise a circuitry for power conversion.

In addition, the input connector 112 may further comprise a switch for turning on/off an input power. In this case, the switch for turning on/off the input power may serve for the same function as a power on/off switch of the entire radar detector 200.

Still yet another embodiment may comprise an output connector 140 for connecting the radar detector 200 to external devices. The output connector 140 may include a power module for allowing the radar detector 200 to supply DC power to external devices 4. Accordingly, for example, when various external devices such as a navigation system, a mobile phone, a smart PC, a PDA, an MP3 player and the like are used in a car having only a few power connections such as a couple of lighter socket jacks, convenience of easy power supply may be provided by connecting such external devices to the radar detector 200 of the present disclosure.

Furthermore, the output connector 140 of the radar detector 200 may be configured to supply data to be visually displayed to the external devices 4. This is especially advantageous if the display unit 114 of the radar detector 200 is, for example, a simple display device such as an LED display of a seven-segment type. Since the information to be represented in the radar detector 200 can be converted to a digital signal and be used as data, an additional advantage of delivering more accurate information to a user may be provided by connecting the radar detector 200 to external devices having a function of providing audio-visual representation.

The present disclosure having the configuration described above can lower power consumption by reducing unnecessary operation time by turning on/off manually by a user or automatically after a predetermined period of time the power supplied to oscillators that generate high-frequency signals to detect high-frequency signals generated from external devices such as a speed gun for monitoring speeding. In addition, the present disclosure promotes user convenience by improving limited power supply connections in automobiles, by associating a radar detector with various external devices such as navigations, mobile phones, smart PCs and so on with not only data communications but also power supply.

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications are intended to be included within the scope of the invention.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A radar detector capable of turning on and off the power of oscillators, comprising:
at least one oscillating unit that receives, through an antenna, electromagnetic waves and generates a signal of a predetermined frequency, and
an oscillating unit controller for turning on and off power supplied to the at least one oscillating unit.

2. The radar detector of claim 1, wherein the power supplied to the oscillating unit controller is configured to be turned on and off manually.

3. The radar detector of claim 1, wherein the power supplied to the oscillating unit controller is configured to be turned on and off automatically by an operating program.

4. The radar detector of claim 1, wherein the power supplied to the oscillating unit controller is configured to be turned on after a period of time preset by an operating program if the power is manually turned off.

5. The radar detector of claim 1, wherein the radar detector further comprises an input connector which receives power from an external DC power source, converts received power to power appropriate for each component in the radar detector, and supplies the power to the component.

6. The radar detector of claim 5, wherein the input connector further comprises a switch for turning on and off input power.

7. The radar detector of claim 1, wherein the radar detector further comprises an output connector capable of supplying DC power to an external device.

8. The radar detector of claim 1, wherein the radar detector further comprises an output connector capable of supplying data to be visually displayed to an external device.

9. The radar detector of claim 1, further comprising:
an input connector which receives power from an external DC power source, converts received power to power appropriate for each component in the radar detector, and supplies the converted power to the component; and
an output connector capable of supplying DC power to an external device.

10. The radar detector of claim 9, wherein the input connector further comprises a switch for turning on and off input power.

11. The radar detector of claim 1, further comprising:
an input connector which receives power from an external DC power source, converts received power to power appropriate for each component in the radar detector, and supplies the converted power to the component; and
an output connector capable of supplying data to an external device for visual display.

12. The radar detector of claim 11, wherein the input connector further comprises a switch for turning on and off input power
